(19) United States
(12) Patent Application Publication
(10) Pub. No.: US 2017/0101294 A1
(43) Pub. Date: Apr. 13, 2017

(54) Hoisting System

(71) Applicant: Emanuel Delgado, Clifton, NJ (US)

(72) Inventor: Emanuel Delgado, Clifton, NJ (US)

(21) Appl. No.: 14/881,514

(22) Filed: Oct. 13, 2015

(51) Int. Cl. B66D 3/12

(52) U.S. Cl. CPC B66D 3/12

(57) ABSTRACT

A hoisting system includes an antenna that includes a main mast. A support is provided and the support may be coupled to a crane thereby facilitating the support to be elevated onto the antenna. The support engages the main mast such that the support is removably coupled to the antenna. A pulley is coupled to the support and a line is extended through the pulley. The line may have an object coupled thereto. The line is selectively urged through the pulley such that the line urges the object upwardly on the main mast.

### BACKGROUND OF THE DISCLOSURE

### Field of the Disclosure

The disclosure relates to hoisting devices and more particularly pertains to a new hoisting device for hoisting an object to a top end of an antenna.

### SUMMARY OF THE DISCLOSURE

An embodiment of the disclosure meets the needs presented above by generally comprising an antenna that includes a main mast. A support is provided and the support may be coupled to a crane thereby facilitating the support to be elevated onto the antenna.

The support engages the main mast such that the support is removably coupled to the antenna. A pulley is coupled to the support and a line is extended through the pulley. The line may have an object coupled thereto. The line is selectively urged through the pulley such that the line urges the object upwardly on the main mast.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a hoisting system according to an embodiment of the disclosure.

FIG. 2 is a top view of an embodiment of the disclosure.

FIG. 3 is a right side view of an embodiment of the disclosure.

FIG. 4 is a top perspective view of an embodiment of the disclosure.

FIG. 5 is a perspective in-use view of an embodiment of the disclosure.

### DESCRIPTION OF THE PREFERRED EMBODIMENT

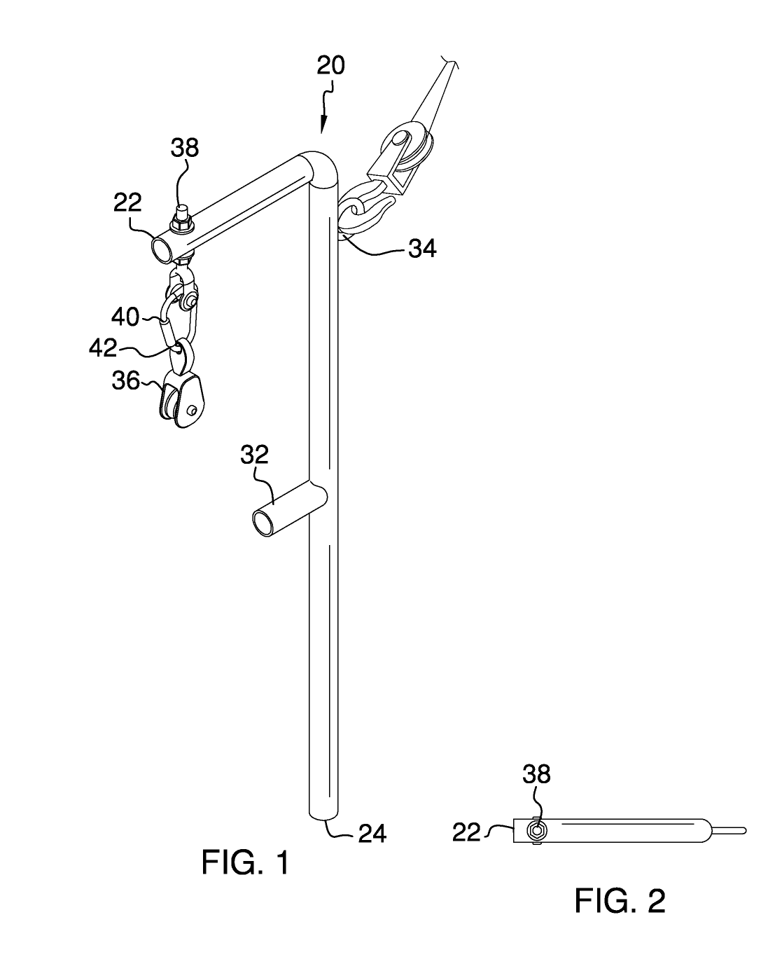

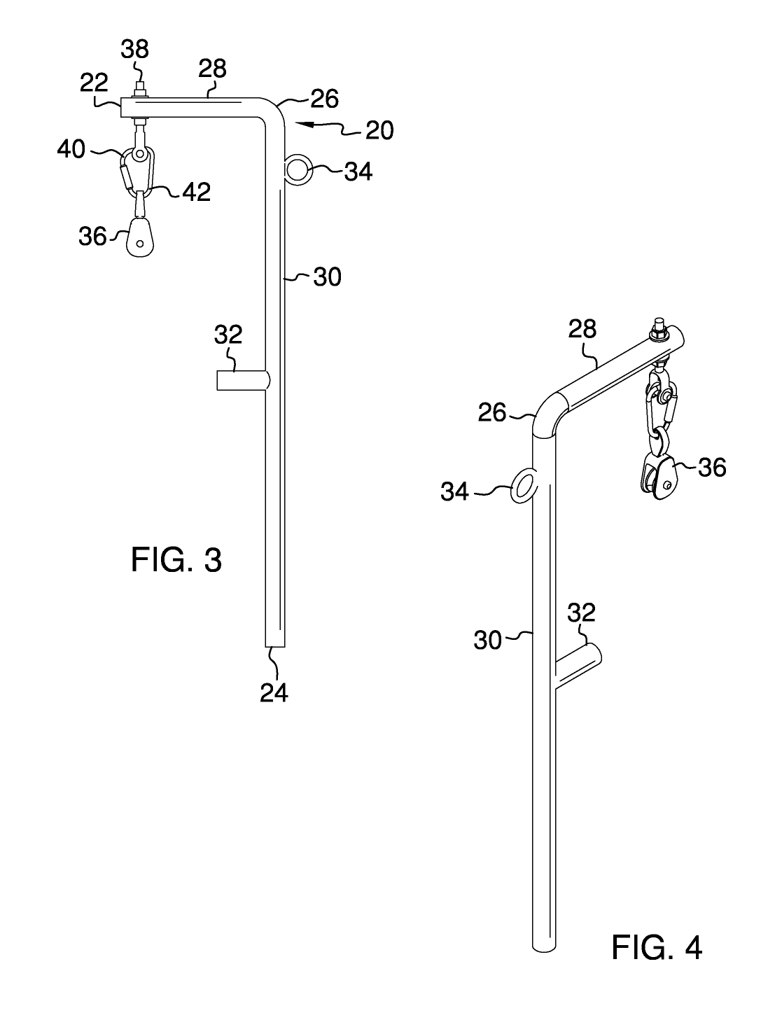

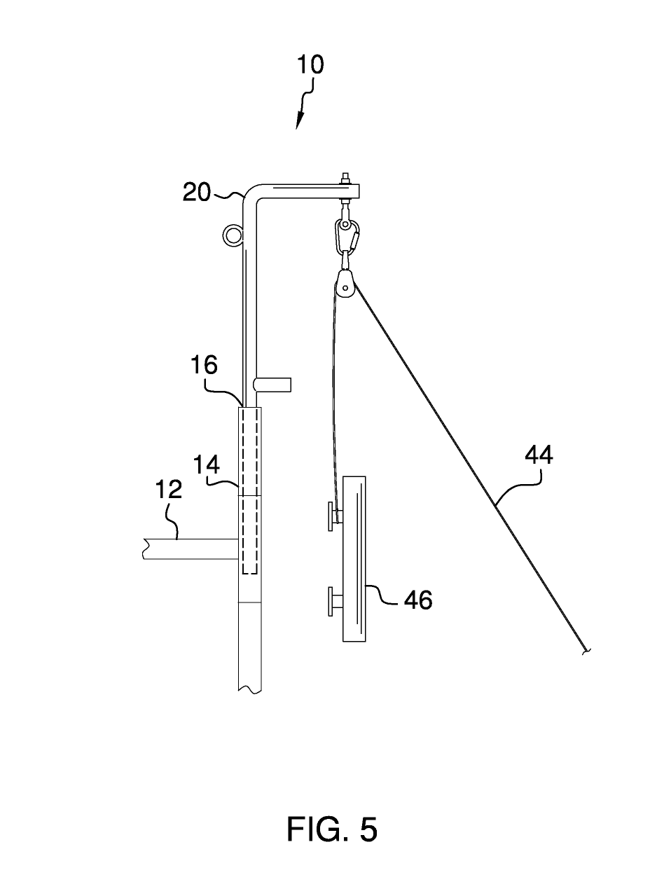

With reference now to the drawings, and in particular to FIGS. 1 through 5 thereof, a new hoisting device embodying the principles and concepts of an embodiment of the disclosure and generally designated by the reference numeral 10 will be described.

As best illustrated in FIGS. 1 through 5, the hoisting system 10 generally comprises an antenna 12 that includes a main mast 14. The main mast 14 has a top end 16 and the top end 16 is open. The antenna 12 may be a communications antenna or the like and the antenna 12 may have a height requiring a crane 18 to access the top end 16. The crane 18 may be a crane of any conventional design.

A support 20 is provided and the support 20 may be coupled to the crane 18 thereby facilitating the support 20 to be elevated onto the antenna 12. The support 20 engages the main mast 14 such that the support 20 is removably coupled to the antenna 12. The support 20 has a first end 22 and a second end 24 and the support 20 has a bend 26 thereon. The bend 26 is positioned closer to the first end 22 than the second end 24 such that the bend 26 defines a first section 28 forming an angle with respect to a second section 30. The top end 16 insertably receives the second end 24 when the support 20 is elevated onto the antenna 12 such that the first section 28 extends laterally away from the main mast 14. The support 20 may have an outside diameter ranging between approximately one inch and two inches.

The support 20 includes a stop 32 that is coupled to the support 20. The stop 32 extends away from the second section 30 and the stop 32 is aligned with the first section 28. The stop 32 is positioned between the second end 24 and the bend 26. The stop 32 engages the top end 16 of the main mast 14 when the second end 24 is inserted into the top end 16 thereby retaining the support 20 in the top end 16.

A ring 34 is coupled to the support 20 and the ring 34 is positioned on the second section 30. The ring 34 is positioned closer to the bend 26 than the second end 24. The ring 34 may be coupled to the crane 18 thereby facilitating the support 20 to be hoisted onto the top end 16. The ring 34 may have a diameter ranging between approximately two inches and three inches.

A pulley 36 is provided and the pulley 36 is coupled to the support 20. The pulley 36 may include a fastener 38 and a coupler 40. The fastener 38 may extend through the first section 28 and the fastener 38 may be positioned closer to the first end 22 than the bend 26. The coupler 40 may be movably coupled to the fastener 38 and the coupler 40 may have a distal end 42 with respect to the fastener 38. The pulley 36 may be movably coupled to the distal end 42 such that the pulley 36 is movably coupled to the support 20. The pulley 36 extends downwardly from the first section 28.

A line 44 is provided and the line 44 extends through the pulley 36. The line 44 may have an object 46 coupled thereto. The object 46 may be a piece of equipment utilized with communication antennas. The line 44 is selectively urged through the pulley 36 such that the line 44 urges the object 46 upwardly to the top end 16 of the main mast 14. The line 44 may comprise a metal cable or the like.

In use, the line 44 is extended through the pulley 36 and the crane 18 is coupled to the ring 34. The crane 18 is used to hoist the support 20 up to the top end 16 of the main mast 14. The second end 24 of the support 20 is inserted into the top end 16 until the stop 32 engages the top end 16. The object 46 is attached to the line 44 and the line 44 is manipulated to urge the object 46 upwardly to the top end 16. The support 20 facilitates the object 46 to be positioned proximate the top end 16 thereby facilitating the object 46 to be coupled to the main mast 14. The support 20 eliminates the need to utilize the crane 18 to hoist and position the object 46 with respect to the top end 16.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hoisting system comprising:
an antenna including a main mast;
a support being configured to be coupled to a crane thereby facilitating said support to be elevated onto said antenna, said support engaging said main mast such that said support is removably coupled to said antenna;
a pulley being coupled to said support; and
a line being extended through said pulley, said line being configured to have an object coupled thereto, said line being selectively urged through said pulley wherein said line is configured to urge the object upwardly on said main mast.

2. The system according to claim 1, wherein:
said main mast has a top end, said top end being open; and
said support has a first end and a second end, said support having a bend thereon, said bend being positioned closer to said first end than said second end such that said bend defines a first section forming an angle with respect to a second section, said top end insertably receiving said second end when said support is elevated onto said antenna such that said first section extends laterally away from said main mast.

3. The system according to claim 2, wherein said support includes a stop being coupled to said support, said stop extending away from said second section, said stop being aligned with said first section, said stop being positioned between said second end and said bend, said stop engaging said top end of said main mast when said second end is inserted into said top end thereby retaining said support in said top end.

4. The system according to claim 2, wherein said support further includes a ring being coupled to said support, said ring being positioned on said second section, said ring being positioned closer to said bend than said second end, said ring being configured to be coupled to the crane thereby facilitating said support to be hoisted onto said top end.

5. The system according to claim 1, wherein:
said support has a first section, a first end and a bend; and
said pulley being positioned on said first section, said pulley being positioned closer to said first end than said bend, said pulley extending downwardly from said first section.

6. A hoisting system comprising:
an antenna including a main mast, said main mast having a top end, said top end being open;
a support being configured to be coupled to a crane thereby facilitating said support to be elevated onto said antenna, said support engaging said main mast such that said support is removably coupled to said antenna, said support having a first end and a second end, said support having a bend thereon, said bend being positioned closer to said first end than said second end such that said bend defines a first section forming an angle with respect to a second section, said top end insertably receiving said second end when said support is elevated onto said antenna such that said first section extends laterally away from said main mast, said support including:
a stop coupled to said support, said stop extending away from said second section, said stop being aligned with said first section, said stop being positioned between said second end and said bend, said stop engaging said top end of said main mast when said second end is inserted into said top end thereby retaining said support in said top end, and
a ring being coupled to said support, said ring being positioned on said second section, said ring being positioned closer to said bend than said second end, said ring being configured to be coupled to the crane thereby facilitating said support to be hoisted onto said top end;
a pulley being coupled to said support, said pulley being positioned on said first section, said pulley being positioned closer to said first end than said bend, said pulley extending downwardly from said first section; and
a line being extended through said pulley, said line being configured to have an object coupled thereto, said line being selectively urged through said pulley wherein said line is configured to urge the object upwardly to said top end of said main mast.
